(19) United States
(12) Patent Application Publication
(10) Pub. No.: US 2006/0168771 A1
(43) Pub. Date: Aug. 3, 2006

(54) Strand Hub

(76) Inventor: Stephan W. Tillitski, Athens, GA (US)

Correspondence Address: Stephan W. Tillitski, 180 Cypress Manor Ln., Athens, GA, 30606, US

(21) Appl. No.: 11/047,530

(22) Filed: Feb. 1, 2005

(51) Int. Cl. F16G 11/00

(52) U.S. Cl. 24/122.6

(57) ABSTRACT

A Strand Hub for use with a multi-strand steel cable for securing multiple trees or multiple poles together includes an outer body made of aluminum or another suitable soft metal with tapered openings extending therethrough. The Strand Hub also includes tapered inner bodies made of stainless steel or other suitable hard metal with a central bore extending therethrough for receiving a single strand of the multi-strand steel cables therein, and is sized and configured to be received in and cooperate with the tapered openings in the outer body. With this construction, the multi-strand steel cable can be partially unwound and a single strand threaded through the central bores in the tapered inner bodies, and the remaining strands can be threaded between the inner body and the outer bodies. The single middle strands are then bent over the tapered inner bodies to quickly and easily fix the Strand Hub on the multi-strand steel cables, thereby securing the trees or poles together.

### TECHNICAL FIELD

The present invention relates generally to rigging and in particular to a cable attachment for securing steel cable to multiple trees, power poles, and the like.

### BACKGROUND OF THE INVENTION

In the field of rigging, it is often necessary to secure one pole to another or to secure one part of a tree to the remainder of the tree, or to simply secure a tree against falling over. To provide this kind of structural support, one end of a cable is attached to the tree or pole to be supported, and the other end of the cable is attached to another object. However, the mechanics of attaching the cable to a tree or pole can present certain technical difficulties in the field. There are also instances when it is desirable or necessary to secure three to five poles or trees or attachments, such as but not limited to streetlights, together. The Strand Hub is designed to address these types of instances.

In such an application, steel cables, such as multi-strand steel cables, typically have been used and are still used today to support trees, power poles, and similar items. Such cables are typically attached to three poles or trees on the inside of the installation by what is commonly known as a “hub and spoke” system. This system is typically comprised of a forged steel ring in the center, surrounded by terminal hardware that might include pre-formed wraps and thimbles, or alternatively, a steel ring, a product called a “strand vise.” Either way, the system requires multiple parts and is comparatively large when installed.

The above described attachment techniques suffer from requiring multiple parts to secure the steel cable. Also, the system when installed is large, unsightly, and is given to failure because of constant metal-to-metal wear inherent in the system. These attachment techniques also tend to be difficult to use in close quarters, such as when the trunks of a tree are closer together than about three feet or so.

Accordingly, it can be seen that a need yet remains in the art for a device for attaching steel cable to multiple trees and poles. Such a device should be strong, easily used in the field, compact, and involve few parts. The present invention is primarily directed toward the provision of such a device.

### SUMMARY OF THE INVENTION

Briefly described, a Strand Hub is intended for use with a multi-strand steel cable for securing multiple trees and poles together for support, or to hang street lights, signs and the like. The Strand Hub is made of an outside block (A) of metal machined so that three tapered holes (B) are spaced at 120 degrees, or alternately five holes spaced at 72 degrees, depending on the number of trees/poles that need to be supported together. In addition, the holes are offset enough that the cables do not touch each other in the center of the block. The internal tapers (C) are machined to fit inside the block's tapered holes, securing the multi-strand steel cable (D) and a single middle strand (E) of the multi-strand cable bent over to fix the internal taper onto the multi-strand steel cable.

### BRIEF DESCRIPTION OF THE DRAWING FIGURES

FIG. 1 is a side view of a Strand Hub, showing the outside aluminum block (A), the three tapered holes (B), a stainless steel internal taper (C), strands (D) of a multi-strand steel cable (H) extending therethrough, and the single middle strand (E) of the multi-strand cable bent over to fix the internal taper onto the multi-strand steel cable.

FIG. 2 is an end view of the Strand Hub of FIG. 1, showing the aluminum block (A), the inner stainless steel tapers (C), strands (D) of a multi-strand steel cable (H) extending therethrough, and the single middle strand (E) of the multi-strand cable (H) bent over to fix the internal taper onto the multi-strand steel cable.

FIG. 3 is an end view of the inner taper (C) of the Strand Hub and the hole (F) that accepts the single strand of the multi-strand steel cable.

FIG. 4 is a sectional side view of the inner taper (C) of the Strand Hub and the hole (F) that accepts the single strand of the multi-strand steel cable.

FIG. 5 is a sectional end view of the outer block (A) with the three tapered inner bores (B).

FIG. 6 is sectional side view of the aluminum block (A) of the Strand Hub and the internal bores (B).

FIG. 7 is a side view of the Strand Hub block (A) with the internal bores (B). Also shown are the accommodating groves (G) that are formed in the softer outer block when pressure is applied to the multi-strand steel cable being held by the Strand Hub.

### DETAILED DESCRIPTION OF EXAMPLE EMBODIMENTS

The present invention may be understood more readily by reference to the following detailed description of the invention, taken in connection with the accompanying drawing figures, which form a part of this disclosure. It is to be understood that this invention is not limited to the specific metals, devices, methods, conditions, or parameters described and/or shown herein, and that the terminology used herein is for the purpose of describing particular embodiments by way of example only, and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. Moreover, while the invention is described in connection with the use of multi-strand steel cable, it will be recognized that the invention is not limited to such use and that other types of cable, wire, and the like can be used with the present invention.

With reference now to the drawing figures, a Strand Hub includes an outer body (A) with three or five tapered openings defined by tapered surface extending therethrough (B). Although the depicted embodiment has a round-shaped outer body and three tapered openings FIGS. (1-6-7), those skilled in the art will recognize that other shapes can be employed, such as round, triangular, hexagonal, etc. Also, more holes can be employed to accommodate more poles/trees to be supported. Indeed, these alternative shapes and variations are within the scope of the present invention. The shape and the size of the outer body (A) may depend on the intended use of the Strand Hub. In the embodiment illustrated in these figures, the outer body (A) is formed to be secured on the inner area between multiple structures being rigged, for example, poles or trees. Preferably, the outer body (A) and the inner taper (C) of the Strand Hub are made of a corrosion-resistant steel or other suitable material. The applicant has found aluminum to work well for the outer body and stainless steel to work well for the inner-tapered body. While steel has high strength, the softer aluminum provides a very good hold, while minimizing the tendency to cut or break the individual strands of the multi-strand steel cable. It is also possible to use brass or other combinations of materials for some or all of the Strand Hub. However, it is important for obtaining a secure initial hold and continuing to hold at the highest possible pressures, that the inner body be made of a material harder than that of the outer body.

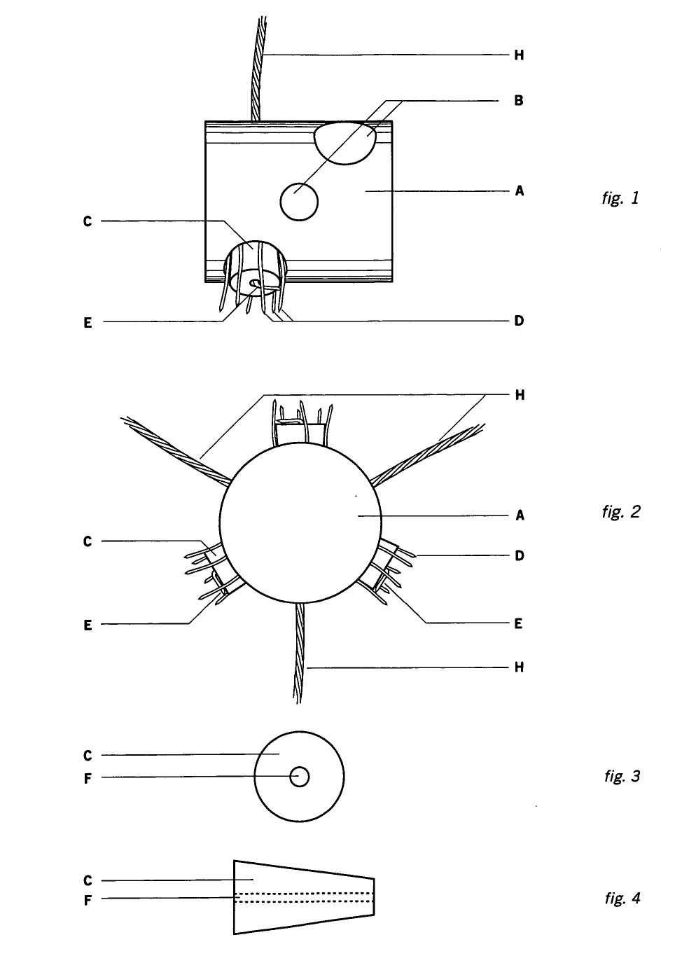

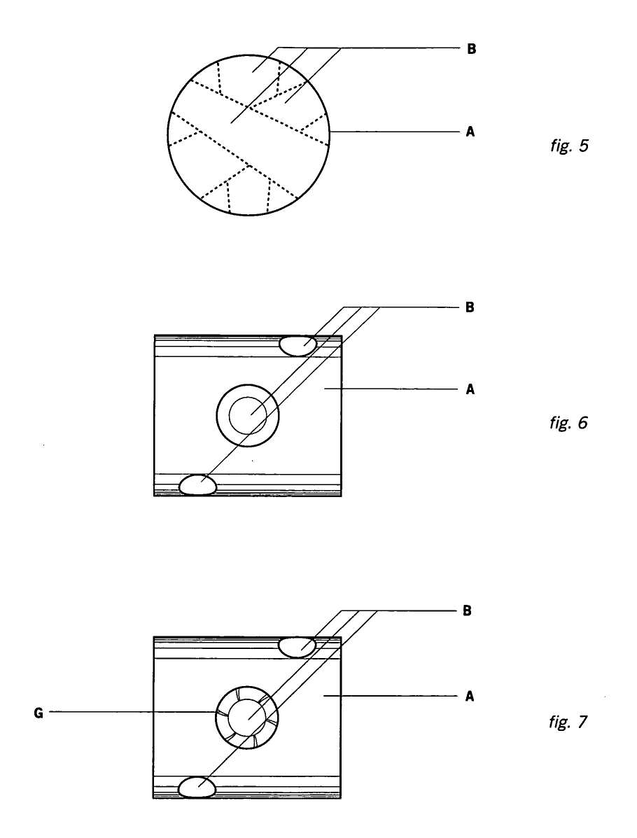

The Strand Hub also includes a tapered inner body (C). The tapered inner body (C) is sized and configured to be received in and to cooperate with the tapered openings (B) in the outer body (A). In the depicted embodiments (FIG. 1-2), the inner-tapered body (C) has a complementary frustoconical shape to be closely received within the opening (B) of the outer body (A). The inner body (C) includes a central bore (F) extending therethrough for receiving the central strand (E) of the multi-strand steel cable (D) therein.

In using the Strand Hub to attach a multi-strand steel cable to trees or poles, the multi-strand steel cable (H) can be partially unraveled and the individual strands (D) can be threaded into the Strand Hub. Preferably, the central strand (E) is threaded through the central bore (F) in the tapered inner body (C), and the outer strands (H) are slipped between the inner body (C) and the outer body (A). The Strand Hub is then secured or fixed onto the multi-strand steel cable quickly and easily by bending the single middle strand of the multi-strand steel cable over the inner body (C). Upon the application of a tensile force on the cable, the strands pull the inner body (C) into the outer body (A), whereby the Strand Hub holds the cable fast in a static state. Preferably, the outer body (A) and the inner body (C) are fabricated from high-strength metals that are durable and resistant to corrosion. However, it is possible to incorporate other, less durable materials for rigging procedures demanding less durability and corrosion resistance, so long as the material will maintain the tensile load applied upon it and the outer body is softer than the inner body.

While the invention has been described with reference to preferred and exemplary embodiments, it will be understood by those skilled in the art that a variety of modifications, additions and deletions can be made therein without departing from the spirit and scope of the invention, as defined by the following claims.

I claim:

1. The Strand Hub for use with a multi-strand steel cable, the Strand Hub comprising: an outer body with tapered openings extending therethrough; tapered inner bodies being sized and configured to be received in and cooperate with the tapered openings in the outer body; wherein a multi-strand steel cable can be partially unraveled and the individual strands of the steel cable can be threaded between the inner bodies and the outer body; and wherein, upon the application of tensile force on the steel cables, the steel cables can be held fast by the Strand Hub.

2. The Strand Hub as claimed in claim 1, wherein the tapered inner bodies have a central bore extending therethrough for receiving a strand of the multi-strand steel cable therein, and wherein a single strand of the steel cable can be threaded through the central bore in the tapered inner bodies and the remaining strands can be threaded between the inner bodies and the outer body.

3. The Strand Hub as claimed in claim 1 wherein the tapered inner bodies have a frustoconical shapes and the tapered opening in the outer body has a similar taper.

4. The Strand Hub as claimed in claim 1 is quickly, easily, and securely fixed to the multi-strand steel cable by bending the single middle strand of the multi-strand steel cables over the internal tapered bodies.

5. The Strand Hub as claimed in claim 1 is uniquely made of dissimilar metals so that the inner tapered body is harder than the outer body.

6. The Strand Hub as claimed in claim 1 is easier to install because of claim 4, and holds more weight because of its unique configuration, as seen in claim 5, than similar inventions such as Maras (U.S. Pat. No. 3,229,341), Youngblood (U.S. Pat. No. 3,475,795), Kucherry (U.S. Pat. No. 4,055,365), Ehert (U.S. Pat. No. 3,676,899), Marchand (U.S. Pat. No. 985,915), and Fiege (U.S. Pat. No. 201,686).

7. The Strand Hub as claimed in claim 1 is able, because of its unique construction in claim 5, to set easily and yet hold firmly in situations of changing tension typically found in trees or power poles when the wind blows, causing the cables to slacken or tighten.
